(19) United States
(12) Patent Application Publication
(10) Pub. No.: US 2006/0153362 A1
(43) Pub. Date: Jul. 13, 2006

(54) Network interface device for fiber optic communications network

(76) Inventors: Stephen G. Bloodworth, Ft. Worth, TX (US); Scott C. Burns, Keller, TX (US); Brad N. Grunwald, Euless, TX (US); Michael K. James, Ft. Worth, TX (US); John A. Keenum, Haltom City, TX (US); John J. Napiorkowski, Irving, TX (US); Chanh C. Vo, Keller, TX (US)

Correspondence Address: CORNING CABLE SYSTEMS LLC, P O BOX 489, HICKORY, NC, 28603, US

(21) Appl. No.: 11/035,244

(22) Filed: Jan. 13, 2005

(51) Int. Cl. H04M 1/00

(52) U.S. Cl. 379/413.02

(57) ABSTRACT

A network interface device (NID) for a fiber optic communications network is provided for housing optical, electrical and/or coaxial connections and active and/or passive components. The NID includes a base and a movable panel defining a connections area and a components area. In one embodiment, a first base defines a first compartment for housing the panel and a second base defining a second compartment for storing drop cable slack, the first base being movably attached to the second base to provide access to the drop cable slack without disturbing the connections. In another embodiment, the panel defines a first compartment for optical and electrical connections and a second compartment for active and passive components, the second compartment being accessible to only the service provider. In another embodiment, the panel is removable and interchangeable to permit the service provider to upgrade the services or to expand services provided to a subscriber.

### BACKGROUND OF THE INVENTION

1. Field of the Invention

The present invention relates generally to an enclosure for providing communications services to a subscriber premises in a fiber optic communications network. More particularly, the invention is a network interface device (NID) for connecting a network fiber optic drop cable to subscriber wiring at a subscriber premises in a fiber optic communications network.

2. Technical Background

Communications service providers are currently installing fiber optic communications networks that extend to homes and businesses. Such networks are commonly referred to as to as “fiber-to-the-home (FTTH)” or “fiber-to-the-business (FTTB)” networks, and the homes and businesses are commonly referred to as “subscriber premises.” As with conventional copper communications networks, there is a need in a fiber optic network for an enclosure, referred to herein as a network interface device (NID), located at the subscriber premises that provides convenient access to the connections between the fiber optic network and the subscriber wiring. The NID serves as the mandatory demarcation point between the fiber optic cable routed to the NID, referred to herein as the “network fiber optic drop cable” or “drop cable,” and the subscriber wiring. Depending on the type of communications services provided and the subscriber's communications equipment, the subscriber wiring may be a fiber optic cable containing one or more optical fibers, an electrical cable containing one or more electrical conductors (e.g. twisted wire pairs), or a coaxial cable containing a central electrical conductor and a concentric ground. Similarly, the communications services may initially be provided by an electrical drop cable or a coaxial drop cable that is subsequently replaced by a fiber optic drop cable.

The NID permits the service provider to access the terminating devices that connect the network drop cable and the subscriber wiring, as well as any passive or active components housed within the NID, for installation, reconfiguration and test operations. Such active components may include, for example, optical-to-electrical converters for converting optical signals to electrical signals and electrical signals to optical signals. At the same time, the NID is typically configured to prevent unauthorized access to the passive or active components belonging to the service provider. As a result, the NID is usually mounted in a location having restricted access, such as a utility closet inside the subscriber premises. Alternatively, the NID may be mounted outside the subscriber premises, for example a home, and provided with a protective outer cover that can be opened only by the subscriber and the service provider to access the connections. The NID is further provided with an inner cover having a security feature to prevent the subscriber and others from accessing the passive or active components belonging to the service provider that are housed within the enclosure.

Typically, the passive or active components belonging to the service provider are installed on the same vertical plane inside the NID as the connections to the subscriber wiring, thereby utilizing a significant amount of space and requiring the NID to have a relatively large footprint. In addition, communications service providers are increasingly demanding the use of standard length pre-connectorized drop cables to reduce material and field labor costs. Consequently, there is often an excess length of the network drop cable, referred to herein as drop cable slack, which must be coiled and stored in an accessible, yet aesthetic manner. Current practice is to coil and store the drop cable slack within the NID above or below the termination equipment (e.g. furcations, fanout kits, splice trays, routing guides, adapters, surge protectors, etc.) and the optical, electrical or coaxial connections. Alternatively, the drop cable slack is coiled and stored within a separate slack storage enclosure mounted near the NID. The downstream end of the drop cable is then routed from the slack storage enclosure to the NID. When the drop cable slack is stored within the NID, the connections must be disturbed if it becomes necessary to remove the drop cable slack for repair (e.g., re-connectorization) or replacement. When the drop cable slack is stored in a separate slack storage enclosure mounted near the NID, cable routing, drip loop and aesthetic considerations must be accommodated.

Accordingly, it would be desirable to provide a NID that is adapted to accommodate optical, electrical and/or coaxial connections, while providing the mandatory demarcation point between the service provider and the subscriber and preventing unauthorized access to the passive or active components belonging to the service provider. At the same time, it would be highly desirable to utilize the NID instead of a separate slack storage enclosure to coil and store drop cable slack in an accessible and aesthetic manner, thereby minimizing additional material, tooling, manufacturing and installation costs, without disturbing the optical, electrical and/or coaxial connections within the ND.

### SUMMARY OF THE INVENTION

One broad aspect of the present invention includes a network interface device (NID) for connecting at least one optical fiber of a network fiber optic drop cable with at least one electrical wire (e.g. a twisted wire pair) of subscriber wiring leading from communications equipment at a subscriber premises. The NID comprises a first base having a first floor and a first sidewall defining an outer compartment for housing optical connections, terminating devices and electrical connections, and a second base having a second floor and a second sidewall defining an inner compartment for storing drop cable slack, the first base being movably attached to the second base.

In another broad aspect of the invention, a NID comprises a base having a floor and a first sidewall defining a first compartment. A connections area is provided within the first compartment at a first elevation above the floor and a components area is provided within the first compartment between the floor and the connections area at a second elevation different from the first elevation. A second sidewall may be provided such that the floor and the second sidewall define a second compartment radially outwardly from the first compartment for storing drop cable slack.

In another broad aspect of the invention, a NID comprises a base having a floor and a first sidewall defining a first compartment. A first panel having an outer side and an inner side defining a first configuration is removably mounted within the first compartment and interchangeable with a second panel having an outer side and an inner side defining a second configuration. The outer side of the first panel and the second panel defines a connections area, and the inner side of the first panel and the second panel defines a components area. A second sidewall may be provided such that the floor and the second sidewall define a second compartment radially outwardly from the first compartment for storing drop cable slack.

The invention will be understood more easily and other objects, characteristics, details and advantages thereof will become more apparent in the course of the following explanatory description, which is given, without intending to imply any limitation of the invention, with reference to the attached drawings.

### BRIEF DESCRIPTION OF THE DRAWINGS

FIG. 1 is a perspective view of an exemplary embodiment of a network interface device (NID) according to the present invention showing the first compartment of the first base.

FIG. 2 is a perspective view of the NID of FIG. 1 showing the second compartment of the second base.

FIG. 3 is a perspective view of the NID of FIG. 1 showing the rear of the second base.

FIG. 4 is a perspective view of another exemplary embodiment of a NID according to the present invention shown with the protective outer cover in the opened position and the connections and components panel in a first position.

FIG. 5 is a perspective view of another exemplary embodiment of a NID according to the present invention shown with the protective outer cover in the opened position and the connections and components panel in a first position.

FIG. 6 is a perspective view of the NID of FIG. 5 shown with the protective outer cover in the closed position.

FIG. 7 is a perspective view of the NID of FIG. 5 showing the rear of the base.

FIG. 8 is an end view of the NID of FIG. 5 showing the bottom of the NID.

FIG. 9 is a perspective view of the NID of FIG. 5 showing the connections and components panel in a second position rotated outwardly from the first position.

FIG. 10 is a perspective view of another exemplary embodiment of a NID according to the present invention shown with the protective outer cover in the opened position and a first example of an interchangeable connections and components panel disposed within the NID with a Telco door in the closed position.

FIG. 11 is a perspective view of the first example of the interchangeable connections and components panel shown with the Telco door in the opened position.

FIG. 12 is a perspective view of the NID of FIG. 10 shown with a second example of an interchangeable connections and components panel disposed within the NID in a first position.

FIG. 13 is a perspective view of the second example of the interchangeable connections and components panel shown in a second position rotated outwardly from the first position.

FIG. 14 is a perspective view of the NID of FIG. 10 shown with a third example of an interchangeable connections and components panel disposed within the NID in a first position.

FIG. 15 is a perspective view of the third example of the interchangeable connections and components panel shown in a second position rotated outwardly from the first position.

### DETAILED DESCRIPTION OF THE INVENTION

The invention is described more fully hereinafter with reference made to the accompanying drawings, in which preferred embodiments of the invention are shown. The invention may, however, be embodied in many different forms, and therefore, should not be construed as being limited to the particular embodiments shown and described herein. Illustrative embodiments are set forth herein so that this description will be both thorough and complete, and will fully convey the intended scope of the claimed invention while enabling those skilled in the art to make and practice the invention without undue experimentation. Positional terms, such as left, right, top, bottom, front, rear, side, etc., and relational terms, such as larger, smaller, nearer, farther, etc., are utilized herein for purposes of explanation only, and as such, should not be construed as limiting the scope of the invention or the appended claims in any manner.

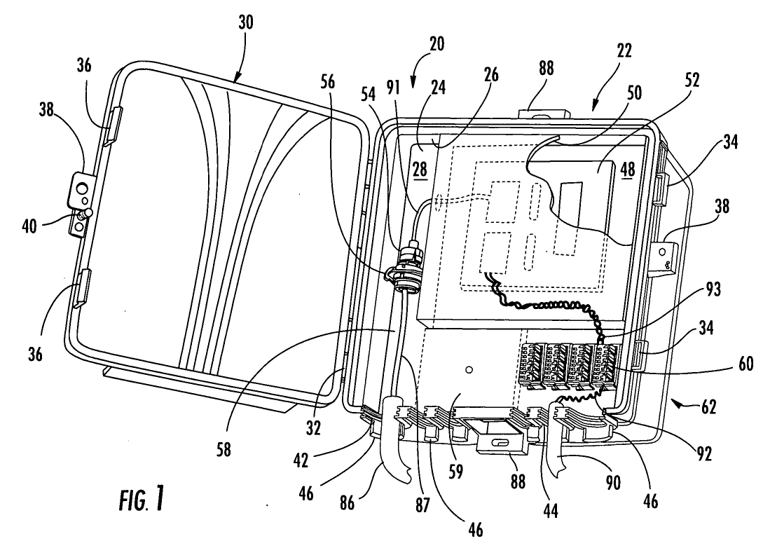

FIGS. 1-3 show an exemplary embodiment of a network interface device (NID) 20 according to the present invention. As best shown in FIG. 1, the NID 20 includes a first base 22 comprising first floor 24 and first continuous sidewall 26 depending upwardly around the periphery of the first floor 24. Together, first floor 24 and sidewall 26 define an outer compartment 28 for housing termination equipment and connections, such as optical, electrical or coaxial connections, as will be described.

NID 20 further comprises protective outer cover 30 movably attached to first base 22. First base 22 and outer cover 30 may be made of any relatively rigid material, for example sheet metal, but preferably are made of a molded plastic, such as PVC, polyethylene, or polypropylene. Outer cover 30 may be movably attached to first base 22 in any suitable manner, but preferably is attached to the first base 22 by one or more hinges 32 provided along one side of first base 22. Accordingly, outer cover 30 pivots about hinges 32 between a closed position and the opened position shown in FIG. 1 to provide access to the outer compartment 28 within the NID 20.

As shown, first base 22 is provided with slots 34 and outer cover 30 is provided with snaps or latches 36 that are received within slots 34 to secure outer cover 30 onto first base 22 in the closed position. First base 22 and outer cover 30 may also be provided with means 38 opposite hinges 32 for locking outer cover 30 onto first base 32. For example, means 38 may comprise a security screw 40 that requires an industry specific tool to remove. Alternatively, means 38 may comprise aligned openings through first base 22 and outer cover 30 that receive a combination or key lock (not shown) belonging to the subscriber. NID 20 is typically mounted in a location having restricted access, such as a utility closet inside a subscriber premises. Alternatively, NID 20 may be mounted outside the subscriber premises and outer cover 30 locked onto first base 22, as described above, to prevent unauthorized access to the termination equipment and connections housed within the NID 20.

At least one network drop cable entry port 42 is provided through first sidewall 26 in communication with outer compartment 28 to permit a network drop cable 86, as will be described hereinafter, to be routed from the network into the NID 20. NID 20 may be provided with any convenient number of network drop cable entry ports 42. Preferably, however, NID 20 is provided with at least one network drop cable entry port 42 for receiving a network fiber optic drop cable from a fiber optic communications network. Entry port 42 may be provided with a removable grommet or breakable seal to prevent contaminants, such as dirt, dust, moisture or infestations, from entering the NID 20 when entry port 42 is not in use. When in use, entry port 42 may also be sealed with a gel or grease around the fiber optic cable in a known manner to prevent contaminants from entering the NID 20. As shown and described herein, entry port 42 for receiving the network drop cable is located along the lower edge of first sidewall 26 adjacent the side of first base 22 having hinges 32. Entry port 42 may, however, be located at any suitable location as long as the entry port 42 remains in communication with outer compartment 28 of NID 20.

First base 22 further comprises at least one subscriber cable entry port 44 that is likewise in communication with outer compartment 28 to permit a subscriber cable 90, as will be described hereinafter, to be routed from the subscriber premises into the NID 20. Subscriber cable entry port 44 provides a means by which a subscriber cable can enter the NID 20 for connection to the drop cable 86 from the network. Preferably, first base 22 comprises a plurality of subscriber cable entry ports 44. As shown, entry ports 44 are located along the lower edge of first sidewall 26 adjacent the side of first base 22 opposite hinges 32. Entry ports 44 may, however, be located at any suitable location as long as the entry ports 44 remain in communication with outer compartment 28 of NID 20.

Both the network drop cable(s) 86 and the subscriber cable(s) 90 may be strain relieved as they enter the outer compartment 28 within the NID 20. For example, drop cable entry port 42 and subscriber cable entry ports 44 may be provided with an arcuate strain relief bracket 46 adjacent the corresponding entry port for strain relieving the network drop cable(s) 86 and/or subscriber cable(s) 90 with a clamping device, such as a conventional cable tie (not shown).

NID 20 includes a components area 48 having a security cover 50 for preventing unauthorized access to the components area 48 and the components therein that belong to the service provider. The cover 50 may be secured over the components area 48, for example, by a security screw that requires an industry specific tool to remove. An original equipment manufacturer (OEM) may provide a printed circuit board (PCB) 52 mounted within the components area 48. Area 48 may be configured for mounting PCB 52 above first floor 24, for example by mounting the PCB 52 to first floor 24 via standoffs. Alternatively, the PCB 52 may be mounted directly or via standoffs to the back side of cover 50 (i.e. the side of cover 50 facing components area 48). As will be appreciated by those skilled in the art, components area 48 may contain optical, electrical or coaxial components. As shown and described herein, components area 48 contains both optical and electrical components, and the PCB 52 includes an optical-to-electrical converter for converting optical signals to electrical signals and electrical signals to optical signals. Accordingly, PCB 52 is commonly referred to as an opto-electronic device or interface. Components area 48 may contain active and/or passive components, and such components may be located and configured on the PCB 52 in any manner desired by the OEM or the service provider.

The portion of outer compartment 28 outside the components area 48 forms a connections area 58. As shown and described herein, NID 20 further includes at least one fiber optic connection 54 mounted to first floor 24 via bracket 56 for connecting one or more optical fibers of the network fiber optic drop cable 86 to one or more optical fiber of a fiber optic pigtail 91. Fiber optic connection 54 may, for example, be a conventional connector adapter sleeve by which one or more fiber optic pigtails 91 are optically connected to the network fiber optic drop cable 86. Alternatively, connection 54 may be an OptiTap™ type fiber optic receptacle available from Corning Cable Systems LLC of Hickory, N.C., for receiving opposing fiber optic connectors mounted upon the ends of the network fiber optic drop cable 86 and the fiber optic pigtail 91. Regardless, fiber optic connection 54 is configured to receive at least one fiber optic connector, such as an SC style connector, on each side. If a connector adapter sleeve or receptacle is used, the optical fibers of the drop cable 86 are preferably connectorized and inserted into one end of the connection 54. At least one connectorized pigtail 91 is then inserted into the other end of the connection 54 to align and optically connect the optical fiber of the pigtail 91 with the corresponding optical fiber of the drop cable 86. Preferably, the network fiber optic drop cable 86 and the fiber optic pigtail 91 are pre-connectorized (i.e. connectorized in the factory) in order to simplify and expedite the connection process, thereby reducing field labor costs. The fiber optic pigtail 91 may then be routed into the components area 48 through an opening provided in cover 50 and optically connected to a passive component on the PCB 52. Alternatively, if the optical fibers of the drop cable 86 are not pre-connectorized, outer compartment 28 may optionally include a conventional splice tray and/or splice holder 59 for aligning and holding one or more splices between optical fibers of the drop cable 86 routed into the splice tray 59 and optical fibers of a transport tube (not shown) spliced thereto by conventional methods well known in the art, such as by mechanical or fusion splicing. The optical fibers contained within the transport tube are then routed through the opening provided in the cover 50 and optically connected to a passive component on the PCB 52.

At least one terminating device 60, such as a conventional insulation displacement 7connector (IDC) shown in FIG. 1 may be mounted onto first floor 24 in outer compartment 28 outside components area 48 (i.e. in the connections area 58). Preferably terminating devices 60 are removably mounted onto first floor 24, such as by the use of conventional slots that engage with feet provided on the terminating devices 60. Jumper wires 93, such as a conventional twisted wire pair, are routed through an opening provided on the cover 50 and used to connect an electrical component within components area 48, for example an optical-to-electrical converter on PCB 52, with a corresponding terminating device 60. The jumper wires 93 may be provided with spades for engaging screw terminals on the terminating device 60, or as shown, inserted into openings on the terminating device 60 to engage the IDC. Subscriber wiring 92, such as a conventional twisted wire pair, from subscriber cable 90 is then connected to the corresponding terminating device 60 so that an electrical connection is made between the subscriber wiring 92 and the electrical component on the PCB 52.

Because certain electrical components are generally susceptible to electromagnetic interference (EMI), the back side of cover 50 desirably may be shielded against EMI, thereby minimizing or eliminating a source of electrical noise on the subscriber wiring 92. Such EMI shielding may be provided by locating a metallic shield between cover 50 and PCB 52. The EMI shield may be in the form of a metallic plate, or may be in the form of a suitable EMI mitigating coating which is applied directly to the back side of cover 50.

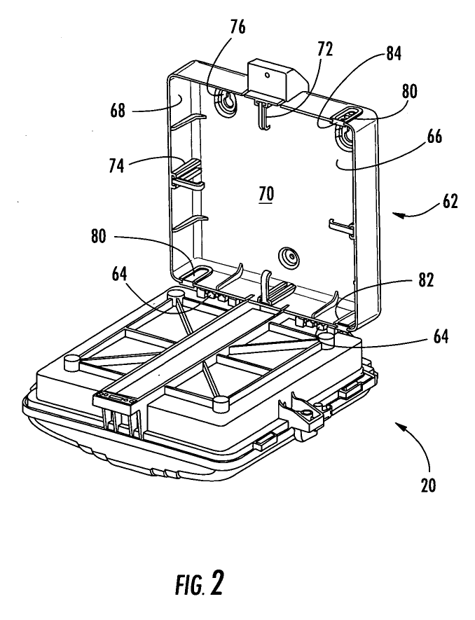

NID 20, as best shown in FIG. 2, further comprises a second base 62 for storing an excess length of the network fiber optic drop cable 86, referred to herein as drop cable slack (not shown). The second base 62 is movably attached to first base 22, such as by hinges 64, so that the drop cable slack may accessed without disturbing the optical and electrical connections in connections area 58. Preferably, hinges 64 are located along the lower edge of second base 62 so that first base 22 may by rotated downwardly about the hinges 64 as shown, thereby providing access to the interior of second base 62.

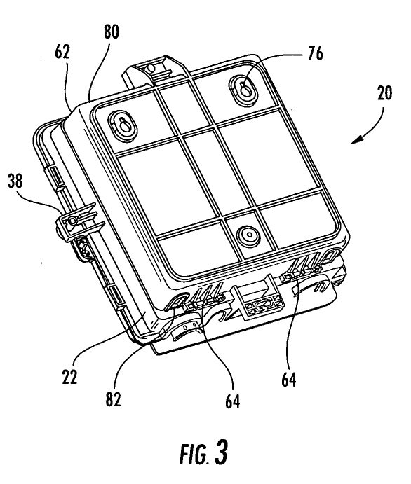

Second base 62 comprises floor 66 and continuous sidewall 68 extending upwardly from the floor 66. Together, floor 66 and sidewall 68 define inner compartment 70 within NID 20 for storing the drop cable slack. Second base 62 may also include retaining members 72 for retaining the drop cable slack in a desired configuration, for example a plurality of stacked coils of the drop cable slack. Retaining members 72 may be removable to facilitate coiling or otherwise positioning the drop cable slack within inner compartment 70. As depicted in FIG. 2, retaining members 72 may, for example, be fitted into slotted receiving portions 74 medially along the inside surface of sidewall 68, and retained by a friction fit, an adhesive, or other methods known in the art. Floor 66 preferably includes slotted openings 76, also shown in FIG. 3, for mounting NID 20, for example to a wall of a structure, using conventional screws. However, the method for mounting NID 20 should not be construed as limiting the invention and NID 20 may be mounted by any other conventional methods known in the art.

Sidewall 68 preferably includes at least one drop cable entry port 80 and at least one drop cable exit port 82. Preferably, drop cable entry ports 80 are located both at the top right-hand side of the second base 62 and at the bottom left-hand side of the second base 62 when NID 20 is mounted on a vertical surface, such as a wall of a structure. Drop cable exit port 82 as depicted in FIGS. 2 and 3, is preferably located at the bottom right-hand side of the second base 62 opposite the entry port 80 located on the top right-hand side of sidewall 68. In this manner, a drop cable 86 may be routed into the second base 62 from above through the top right-hand side cable entry port 80 or from below through the bottom left-hand side cable entry port 80. Regardless, the drop cable slack is coiled in a clockwise manner within the inner compartment 70 under retaining members 72 and routed out of the second base 62 through exit port 82 and into first base 22 through drop cable entry port 42. In this manner, an arcuate drip loop may be formed in drop cable 86 below the NID 20 to prevent moisture from entering the outer compartment 28 through drop cable entry port 42. However, the drop cable entry ports 80 and the drop cable exit port 82 may be positioned at any convenient location along sidewall 68. Positioning exit port 82 along the bottom of second base 62, however, advantageously provides an opening for draining moisture (such as rain or melted snow) from the inner compartment 70. Furthermore, entry ports 80 and exit port 82 may each be fitted with a removable grommet or penetrable seal 84 to prevent contaminants, such as moisture, dirt, or infestations, from entering second base 62.

Second base 62 is particularly useful when a standard length of a pre-connectorized network drop cable 86 is used to reduce field labor costs. In the event that a customized length of a pre-connectorized network drop cable 86 is utilized, or the drop cable 86 is cut to length and connectorized or spliced in the field, second base 62 may be optionally detached from first base 22 at hinges 64 and NID 20, comprising only first base 22, may thereafter be mounted, for example to a wall of a structure, via mounting feet 88 (FIG. 2).

Network drop cable 86 comprises a relatively flexible jacket made of a weatherproof material, such as plastic, for protecting at least one, and preferably at least a pair, of optical fibers. Typically, the jacket of drop cable 86 encases at least one optical fiber contained within a transport tube 87 for protection. As previously described, the drop cable 86 is routed into second base 62 of NID 20 through a drop cable entry port 80. A slack length of the drop cable 86 may be coiled within inner compartment 70 under retaining members 72, or the retaining members 72 may be positioned on the sidewall 68 of the second base 62 after the drop cable slack has been coiled if the retaining members 72 are removable. Typically, the end of the drop cable 86 is then routed out of the second base 62 through cable exit port 82 and into outer compartment 28 of first base 22 through cable entry port 42. Optionally, optical fibers of the drop cable 86 to be used initially are separated from optical fibers that are to be stored within cavity 70 and used later if the subscriber requires additional fiber optic communications service. Unused, or “dark,” optical fibers may be stored as bare optical fiber or in transport tubes within inner compartment 70 along with the slack length of drop cable 86.

Subscriber cable 90 is an optical, electrical or coaxial cable leading from an indoor outlet in a subscriber premises. As shown herein, subscriber cable 90 comprises a relatively flexible jacket made of a weatherproof material, such as plastic, for protecting at least one, and preferably at least a pair, of electrical wires, such as a twisted wire pair. The subscriber cable 90 enters first base 22 of NID 20 through entry port 44 and individual subscriber wires 92 are broken out from the cable jacket within outer compartment 28 and routed directly to a terminating device 60. A fiber optic pigtail 91 is connected to one end of connection 54 opposite the connectorized optical fiber(s) of the drop cable 86 contained within transport tube 87. Alternatively, in the event that drop cable 86 is not connectorized, the optical fiber(s) of the drop cable 86 may be spliced by a conventional method, such as with a mechanical or fusion splice within splice tray or splice holder 59, to un-connectorized optical fiber(s) of the fiber optic pigtail 91. In either event the fiber optic pigtail 91 is routed into components area 48 and optically connected to an optical component on PCB 52. Similarly, jumper wires 93 are connected to one end of terminating device 60 opposite subscriber wiring 92, routed into components area 48 and electrically connected to an electrical component on PCB 52.

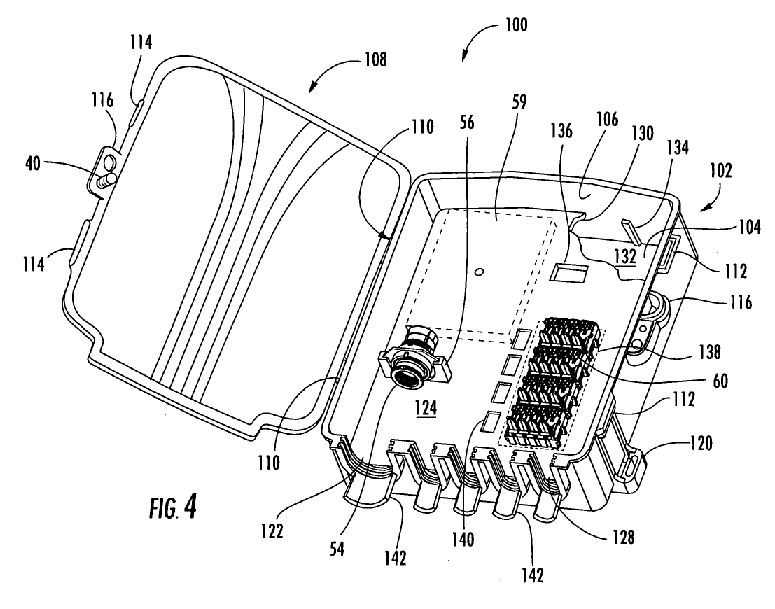

FIG. 4 shows another exemplary embodiment of a NID 100 in accordance with the present invention. NID 100 includes base 102 comprising floor 104 and continuous sidewall 106 depending upwardly around the periphery of the floor 104. NID 100 further comprises a protective cover 108 movably attached to base 102. The base 102 and the cover 108 may be made of any relatively rigid material, such as sheet metal, but preferably are made of a molded plastic, such as PVC, polyethylene, or polypropylene. Cover 108 may be movably attached to base 102 in any suitable manner, but preferably is movably attached to base 102 by one or more hinges 110 located along one side of the base 102 and the cover 108 such that cover 108 pivots about hinges 110 between a closed position and an opened position to provide access to the interior of the NID 100.

As shown, base 102 is provided with slots 112 and cover 108 is provided with snaps 114 that are received within slots 112 to secure cover 108 on base 102 in the closed position. Base 102 and cover 108 may also be provided with means 116 opposite the hinges 110 for locking cover 108 on base 102. For example, means 116 may comprise locking screw 40 that requires an industry specific tool to remove. Alternatively, means 116 may comprise aligned openings through base 102 and cover 108 that receive a combination or key lock (not shown) belonging to the subscriber. Base 102 may be mounted, for example to a wall of a structure, by way of feet 120 provided on base 102. Alternatively, NID 100 may comprise one or more slotted holes (not shown) through floor 104 for mounting NID 100 to a wall at the subscriber premises using conventional screws.

At least one drop cable entry port 122 is in communication with connections area 124 of base 102 to permit a network drop cable (not shown) to be routed into NID 100. NID 100 may be provided with any convenient number of drop cable entry ports 122. Preferably, however, the NID 100 is provided with at least one entry port 122 for receiving a network drop cable, as described hereinabove, from a fiber optic communications network. Entry port 122 may be provided with a removable grommet or penetrable seal (not shown) to prevent contaminants, such as moisture, dirt, or infestations, from entering the NID 100 when entry port 122 is not in use. When in use, entry port 122 may also be sealed with a gel or grease around the fiber optic drop cable in a known manner to prevent contaminants from entering NID 100. As shown and described herein, entry port 122 is located adjacent the hinged side of base 102 and cover 108. However, entry port 122 may be located at any convenient location along the sidewall 106 of base 102. Base 102 further comprises at least one subscriber cable entry port 128 along sidewall 106 to permit a subscriber cable (not shown) to be routed into connections area 124 of NID 100, as previously described.

As shown in FIG. 4, NID 100 further comprises connections and components panel 130 positioned within base 102. Panel 130 is shaped, sized, and configured to be removably mounted within base 102. Additionally, connections and components panel 130 may be hinged such that panel 130 can be rotated outwardly from base 102 about hinges (not shown), thereby providing access to the portion of base 102 behind panel 130, hereinafter referred to as components area 132. Standoffs 134 positioned within components area 132, and preferably along the inside surface of sidewall 106, operate to position the panel 130 at a fixed elevation above floor 104. Once positioned, panel 130 is secured within base 102 by conventional fasteners such as snap locks, screws, rivets, or the like. As such, panel 130 comprises a first compartment in base 102 that defines connections area 124 located on the outer side of panel 130, and a second compartment in base 102 that defines components area 132 located on the inner side of panel 130 (i.e. between floor 104 and the connections and components panel 130). Connections area 124 and components area 132 may be shaped, sized, and located within base 102 in any suitable manner, but are intentionally located on separate elevations with respect to floor 104 in a stacked or layered configuration. OEMs may provide, for example, the previously shown and described printed circuit board PCB 52 mounted within components area 132. Components area 132 may be configured for mounting the PCB 52 on floor 104 or above floor 104, such as by mounting the PCB 52 to floor 104 via standoffs. Similarly, PCB 52 may be mounted on the inner side of panel 130 (i.e. the side of panel 130 facing components area 132) or below panel 130 via standoffs. Components area 132 may contain active components, passive components, or both active and passive components, and such components may be located and configured on the PCB 52 as desired by the OEM in the manner previously described.

As shown and described herein, connections area 124 includes fiber optic connection 54 mounted to the outer side of panel 130 on a mounting bracket 56 for optically connecting one or more optical fibers of the network fiber optic drop cable with one or more optical fibers within the NID 100. If connection 54 is a connector adapter sleeve or receptacle, the optical fiber(s) of the drop cable are preferably pre-connectorized, and the pre-connectorized drop cable is received within one end of the connection 54. At least one connectorized fiber optic pigtail may then be received within the other end of the connection 54 and optically aligned with a corresponding optical fiber on the drop cable. The fiber optic pigtail may then be routed into the components area 132 through an opening in the panel 130, identified in FIG. 4 by panel port 136. The fiber optic pigtail is then optically and physically connected to an optical component within components area 132, such as an optical-to-electrical converter. Panel port 136 may be located at any convenient location on the panel 130. Alternatively, if the optical fibers of the drop cable are not connectorized, connections area 124 may further include a conventional splice tray and/or splice holder 59 for housing one or more splices between the optical fiber(s) of the drop cable and optical fiber(s) spliced thereto by conventional methods as are known in the art, such as by mechanical or fusion splicing.

Terminating devices 60, such as conventional insulation displacement connectors (IDCs) shown in FIG. 4 may be mounted on panel 130. Preferably, terminating devices 60 are removably mounted onto panel 130, such as by the use of conventional slots that engage with feet provided on the terminating devices 60. Alternatively, panel 130 may contain an opening indicated by dashed line 138 in FIG. 4 through which terminating devices 60 mounted on PCB 52 protrude through panel 130 from the components area 132 into the connections area 124. Additional openings 140 may be formed through panel 130 into which OEM-provided connector receptacles or jacks (not shown), such as modular RJ-11 or RJ-45 jacks, may be inserted to receive corresponding plugs from subscriber communications equipment or line testing equipment, such as a conventional handset. The OEM-provided connector receptacles or jacks may be mounted on the outer side of the PCB 52 so that they protrude outwardly through openings 140 when the PCB 52 is mounted within components area 132 of NID 100 and panel 130 is in its fully installed position inside base 102 abutting standoffs 134. The OEM-provided connector receptacles or jacks are electrically connected to an electrical component on the PCB 52 via jumper wires. Alternatively, the jumper wires may be connected between the PCB 52 and one end of a terminating device 60. The subscriber wiring is then connected to the other end of the terminating device 60, as previously described, to electrically connect the subscriber wiring to an electrical component, such as an electrical-to-optical converter, on the PCB 52. For example, the jumper wires may be terminated at the end opposite the terminating device 60 with an appropriate modular plug, such as an OEM-provided RJ-11 plug, which is in turn attached to and electrically connected with an electrical component on the PCB 52.

Components area 132 may be shielded against EMI by locating a suitable shield between panel 130 and PCB 52. The EMI shield may be in the form of a metallic plate, or it may be in the form of a suitable EMI mitigating coating which may be applied directly to the back (i.e. inner) side of panel 130.

As previously described, connections area 124 is located at a first elevation within base 102 on the front (i.e. outer) side of panel 130. Components area 132, on the other hand, is located at a second elevation within base 102 that is different than the first elevation. In particular, components area 132 is located between floor 104 of base 102 and the back (i.e. inner) side of panel 130. Thus, base 102 is divided by panel 130 into a first, outer compartment and a second, inner compartment bordered by sidewall 106.

The network drop cable may be strain relieved as it enters connections area 124 of base 102. As shown herein, drop cable entry port 122 comprises a strain relief bracket 142 for strain relieving the drop cable with a clamping device (not shown), such as a cable tie. Similarly, subscriber cable entry port 128 is comprises a strain relief bracket 142 for strain relieving the subscriber cable as it enters the connections area 124. Furthermore, NID 100 may optionally comprise second base 62, as previously shown and described with respect to the embodiment of FIGS. 1-3, for storing drop cable slack. When so configured, base 102 is movably attached to second base 62, for example by hinges 64, to provide access to the drop cable slack without disturbing the optical and electrical connections within base 102, and second base 62 is secured, for example, to a wall at the subscriber premises.

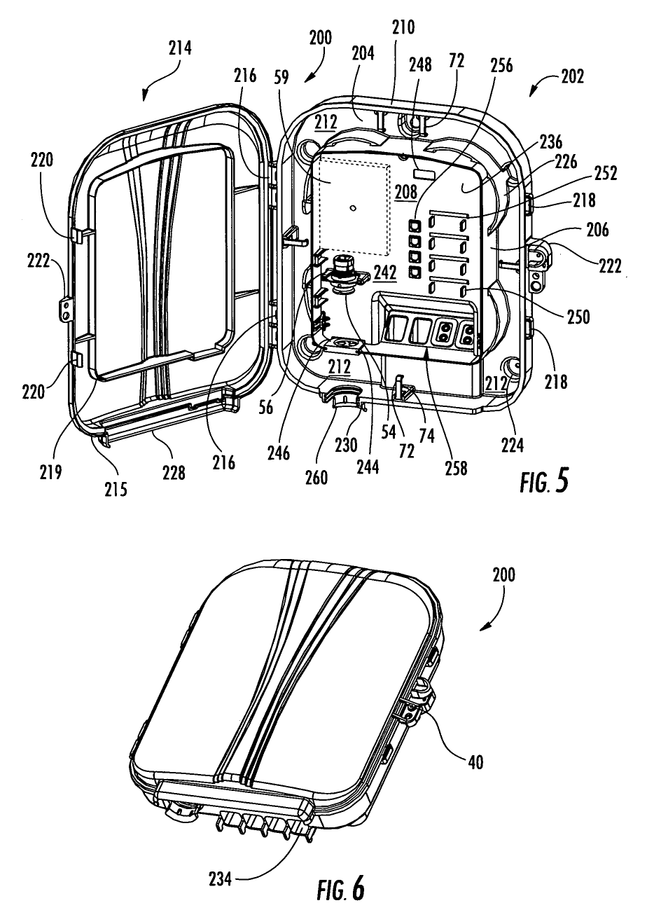

FIGS. 5-9 show another exemplary embodiment of a NID according to the present invention, indicated generally by reference numeral 200. NID 200 includes base 202 comprising floor 204 and a continuous first sidewall 206 depending upwardly from the floor 204 within base 202. Together, floor 204 and first sidewall 206 define a first, inner compartment 208. A second, continuous sidewall 210 depends upwardly from the floor along the outer periphery of the floor 204. The area within the base 202 above floor 204 and between the first sidewall 206 and the second sidewall 210 defines a second, outer compartment 212 disposed about the periphery of the first (i.e. inner) compartment 208.

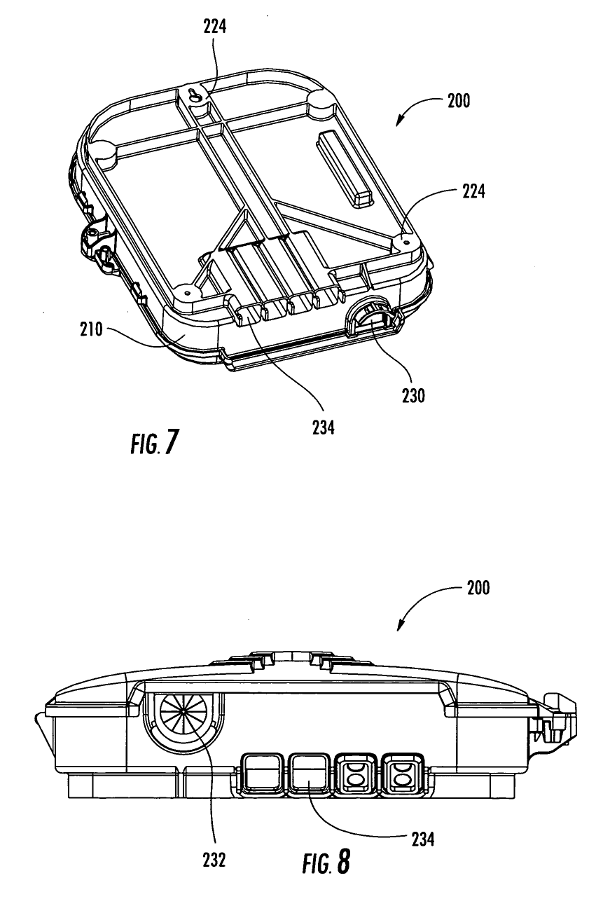

NID 200 further comprises a protective outer cover 214 movably attached to base 202. Base 202 and cover 214 may be made of any relatively rigid material, such as sheet metal, but preferably are made of a molded plastic, such as PVC, polyethylene, or polypropylene. Outer cover 214 is movable between an opened position, as shown in FIG. 5, and a closed position, as shown in FIG. 6. Cover 214 may be movably attached to base 202 in any suitable manner, but preferably is attached to base 202 by one or more hinges 216 located along one side of base 202 and cover 214. Accordingly, cover 214 pivots about hinges 216 between the closed position and the opened position to provide access to the interior of NID 200. A lip 215 is disposed about the periphery of cover 214 and depends inwardly in the direction of base 202. Lip 215 may include a channel (not shown) which extends substantially around the periphery of outer cover 214. Second sidewall 210 preferably abuts lip 215 when cover 214 is in the closed position, and serves as a barrier to the ingress of liquid, such as water, into NID 200. If a channel is provided on lip 215, second sidewall 210 engages within the channel to form a mechanical seal. The channel may optionally include an elastic sealing material, such as a rubber gasket, for improving the seal between cover 214 and base 202. Cover 214 may further include a ridge 219 depending inwardly from the interior surface of outer cover 214. Ridge 219 preferably abuts first sidewall 206 when cover 214 is in the closed position, and provides an additional barrier to the ingress of liquid into first compartment 208. Ridge 219 may optionally include a channel and/or gasket in the manner previously described for lip 215.

As shown, base 202 is provided with slots 218 and cover 214 is provided with snaps 220 that are received within slots 218 to secure cover 214 on base 202 in the closed position. Base 202 and cover 214 may also be provided with means 222 opposite hinges 216 for locking cover 214 on base 202. For example, means 222 may comprise locking screw 40 (FIG. 6) that requires an industry specific tool to remove. Alternatively, means 222 may comprise aligned openings through base 202 and cover 214 that receive a combination or key lock (not shown) belonging to the subscriber. Base 202 may further comprise one or more mounting points 224 (FIG. 7), such as slotted holes or sockets for mounting NID 200 in a known manner to a wall at the subscriber premises using conventional screws. Alternatively, NID 200 may be mounted by way of feet (not shown) provided on base 202. Typically, NID 200 is mounted in a location having restricted access, such as a utility closet inside a subscriber premises. Alternatively, NID 200 may be mounted outside the subscriber premises and cover 214 locked on base 202, as described hereinabove, to thereby prevent unauthorized access to the connections and components housed within the NID 200.

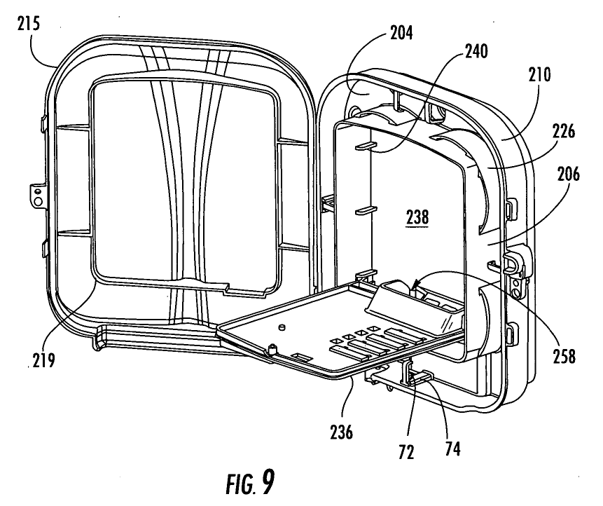

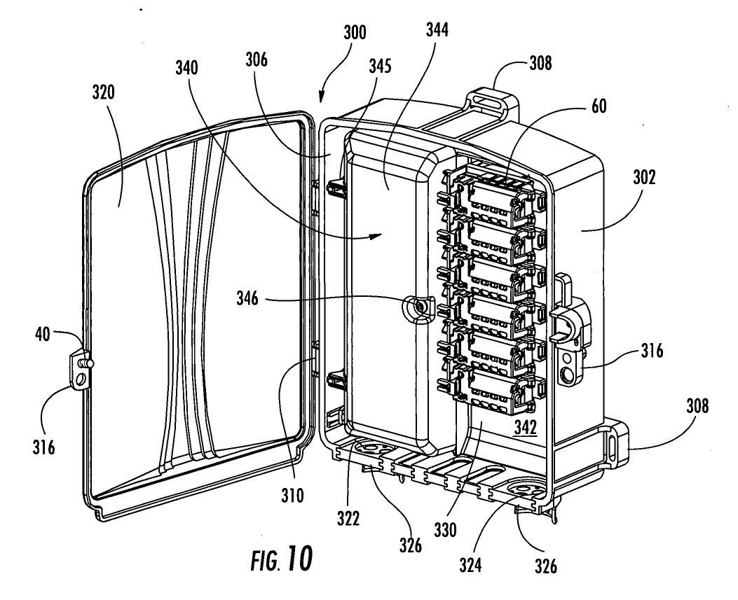

As described, second (i.e. outer) compartment 212 preferably is provided with arcuate inner walls 226 for coiling an excess length of a network fiber optic drop cable containing one or more optical fibers without exceeding the minimum bend radius of the optical fibers and without creating kinks or tight bends which may interfere with the performance of the optical fibers. Preferably, the drop cable slack is coiled loosely between arcuate walls 226 and second sidewall 210. The second compartment 212 may also be provided with retaining members 72 for retaining the drop cable slack within the second compartment 212 in a desired configuration. Retaining members 72 may be removable to facilitate coiling or otherwise positioning the drop cable slack in second compartment 212. As best shown in FIG. 9, retaining members 72 may, for example, be fitted into slotted receiving portions 74 along the inside surface of second sidewall 210, and retained by a friction fit, an adhesive, or other methods known in the art.

As shown, second sidewall 210 extends upwardly from floor 204 a greater distance along the bottom of NID 200. Accordingly, cover 214 has a corresponding recess 228 formed therein to accommodate the extension of second sidewall 210 and at least one drop cable entry port 230. The drop cable entry port 230 is in communication with second compartment 212 to permit a network fiber optic drop cable, as described hereinabove, to be routed into NID 200. NID 200 may be provided with any convenient number of entry ports 230, but typically is provided with only one entry port 230 for receiving a single drop cable containing one or more optical fibers from an optical communications network. Entry port 230 may be provided with a removable grommet or penetrable seal 232 (FIG. 8) to prevent contaminants, such as moisture, dirt, or infestations, from entering the NID 200 when entry port 230 is not in use. When in use, entry port 230 may also be sealed with a gel or grease around the fiber optic drop cable in a known manner to prevent contaminants from entering NID 200. As shown and described herein, drop cable entry port 230 is located adjacent the hinged side of base 202 and cover 214. However, entry port 230 may be located at any convenient location along second sidewall 210 as long as the entry port 230 remains in communication with second compartment 212.

As best shown in FIGS. 6-8, base 202 further comprises at least one passageway 234 through floor 204 of base 202 and in communication with first compartment 208, but not in communication with second compartment 212, for receiving a subscriber cable. Passageway 234 provides a means by which a subscriber cable may enter NID 200 and be routed into first compartment 208 without passing through second compartment 212. Advantageously, passageway 234 extends beneath any drop cable slack which may be stored in second compartment 212, thereby permitting the drop cable slack to be removed from the base 202 of NID 200 without disturbing any subscriber cables routed through passageway 234 and connected within NID 200. Preferably, base 202 comprises a plurality of passageways 234. As shown, passageways 234 are located along the bottom first sidewall 206 and second sidewall 210 opposite hinges 216. However, passageways 234 may be located at any convenient location along the sidewalls 206, 210 as long as each passageway 234 remains in communication with first compartment 208 within base 202.

As described above, base 202 and first sidewall 206 define first compartment 208 for housing optical, electrical and/or coaxial connections and components within NID 200. As best shown in FIG. 9, a removable connections and components panel 236 is positioned within first compartment 208. Panel 236 is shaped, sized, and configured to be movably attached to the floor 204 or to an interior surface of first sidewall 206. Preferably, panel 236 is hinged to the floor 204 or first sidewall 206 such that panel 236 may swing outwardly from first compartment 208 by rotating about the hinges, thereby providing access to that portion of first compartment 208 on the back (i.e. inner) side and behind panel 236, hereinafter referred to as components area 238. A plurality of standoffs 240 are provided within components area 238, preferably about the interior surface of first sidewall 206, to position panel 236 at a fixed elevation above floor 204. Once positioned and secured within first compartment 208 by conventional fasteners, such as snap locks, screws, rivets, or the like, panel 236 defines connections area 242 located on the front (i.e. outer) side and above panel 236. Accordingly, panel 236 separates first compartment 208 into a connections area 242 between panel 236 and outer cover 214 and a components area 238 between panel 236 and floor 204. Connections area 242 and components area 238 may be shaped and sized within first compartment 208 in any desirable manner, but preferably are positioned at different elevations with respect to floor 204 in a stacked or layered configuration. OEMs may provide, for example, PCB 52 previously shown and described mounted within components area 238. Components area 238 may be configured for mounting PCB 52 to floor 204 or above floor 204 via standoffs, or PCB 52 may be similarly mounted to the back side of panel 236 (i.e. the side of panel 236 facing components area 238). First sidewall 206 preferably comprises at least one entry port 244 for routing one or more optical fibers of the network drop cable into first compartment 208, and more particularly into connections area 242. Entry port 244 may be provided with a removable grommet or penetrable seal 246, as shown in FIG. 5, to prevent contaminants, such as moisture, dirt, or infestations, from entering first compartment 208 when entry port 244 is not in use. When in use, entry port 244 may also be sealed with a gel or grease around the fiber optic cable or transport tube containing the optical fiber(s) of the drop cable in a known manner to prevent contaminants from entering the NID 200.

As shown and described herein, connections area 242 may include fiber optic connection 54 mounted to the front (i.e. outer) side of panel 236 on mounting bracket 56 for connecting the optical fiber(s) of the drop cable with one or more optical fibers of fiber optic pigtails, as previously described. Fiber optic connection 54 may, for example, be a connector adapter sleeve or receptacle (such as the OptiTap™ fiber optic receptacle available from Corning Cable Systems LLC of Hickory, N.C.) by which the fiber optic pigtail(s) are optically connected to the optical fiber(s) of the drop cable. If a connector adapter sleeve or receptacle is used, the optical fiber(s) of the drop cable are preferably pre-connectorized and the connector(s) received within one end of the adapter connector sleeve or receptacle. At least one connectorized pigtail is then received within the other end of the connector adapter sleeve or receptacle and optically aligned with a corresponding optical fiber of the drop cable. The fiber optic pigtail is then routed from the connection 54 to the components area through panel port 248. Panel port 248 may be located at any convenient location on the panel 236. Alternatively, if the optical fiber(s) of the drop cable are not connectorized, connections area 242 may optionally include a conventional splice tray and/or splice holder 59 for holding one or more splices between the optical fiber(s) of the drop cable and the fiber optic pigtails spliced thereto by conventional methods well known in the art, such as by mechanical or fusion splicing.

Snap members 250 on the front surface of panel 236 provide mounting locations for terminating devices 60 previously shown and described, such as conventional insulation displacement connectors (IDCs). Grooves 252 formed in the outer surface of panel 236 may be used to accommodate electrical wires from a subscriber cable which may be connected to the terminating devices. Alternatively, panel 236 may contain one or more openings 256 through which PCB-mounted terminating devices may protrude from the PCB 52 through panel 236 from components area 238 into connections area 242. Additional openings 256 may be formed through panel 236 into which OEM-provided connector receptacles or jacks (not shown), such as modular RJ-11 or RJ-45 jacks, may be inserted to receive corresponding plugs from subscriber communications equipment or line testing equipment, such as a conventional handset. The OEM-provided connector receptacles or jacks may be mounted on the outer side of the PCB 52 so that they protrude outwardly through openings 256 when the PCB 52 is mounted within components area 238 of NID 200 and panel 236 is in its fully installed position inside first sidewall 206 of base 202 abutting standoffs 240. The OEM-provided connector receptacles or jacks are electrically connected to an electrical component on the PCB 52 via jumper wires. Alternatively, the jumper wires may be connected between the PCB 52 and one end of a terminating device 60. The subscriber wiring is then connected to the other end of the terminating device 60, as previously described, to electrically connect the subscriber wiring to an electrical component, such as an electrical-to-optical converter, on the PCB 52. For example, the jumper wires may be terminated at the end opposite the terminating device 60 with an appropriate modular plug, such as an OEM-provided RJ-11 plug, which is in turn attached to and electrically connected with an electrical component on the PCB 52.

Panel 236 may further include subscriber cable access opening 258 to provide access to passageways 234 which open into first compartment 208. Thus, subscriber wiring routed into NID 200 passes through at least one passageway 234 and enters connections area 242 through access opening 258. The passageway 234 may be fitted with a removable grommet or penetrable seal adjacent access opening 258 to prevent contaminants, such as moisture, dirt, or infestations, from entering first compartment 208.

As electrical components may be susceptible to electromagnetic interference (EMI), the back (i.e. inner) side of panel 236 desirably may be shielded against EMI, thereby minimizing or eliminating a source of electrical noise on the subscriber wiring. Such shielding may be provided by locating a metallic shield between panel 236 and PCB 52. The EMI shield may be in the form of a metallic plate, or it may be in the form of a suitable EMI mitigating coating which may be applied directly to the back side of panel 236.

As previously described, connections area 242 is located at a first elevation within first compartment 242 of base 202 on the front (i.e. outer) side of panel 236. Components area 238, on the other hand, is located at a second elevation within first compartment 208 of base 202 that is different than the first elevation. In particular, components area 238 is located between floor 204 of base 202 and the back (i.e. inner) side of panel 236. Thus, first compartment 208 is divided by panel 236 into a first, outer connections area 242 and a second, inner components are 238 bordered by first sidewall 206.

Second compartment 212 manages the drop cable that enters the NID 200 through drop cable entry port 230. If desired, the drop cable may be strain relieved as it enters second compartment 212. As shown herein, entry port 230 comprises a strain relief bracket 260 for strain relieving the drop cable with a clamping device (not shown), such as a cable tie. In addition, an excess length of the drop cable may be stored within the second compartment 212 between arcuate walls 226 and second sidewall 210. As previously described, second compartment 212 further comprises at least one, and preferably a plurality, of retaining members 72 that project into the second compartment 212 for retaining the drop cable slack between the floor 204 and the retaining members 72.

Connections area 242 further manages the optical fiber(s) of the drop cable that enter the first compartment 208 of NID 200 through entry port 244. Connections area 242 is accessible to both the service provider and the subscriber and serves as the mandatory demarcation point for the optical, electrical and/or coaxial connections between the network and the subscriber wiring. In particular, the optical fiber(s) of the drop cable are first connectorized (and preferably, pre-connectorized) and then optically connected through connection 54 to connectorized fiber optic pigtail(s). The fiber optic pigtail(s) are then routed through panel opening 248 to PCB 52 and optically connected to an optical component in the components area 238, such as an optical-to-electrical converter to convert the optical signals to electrical signals. Similarly, a subscriber cable containing subscriber wiring is first routed through passageway 234 into connections area 242 and the subscriber wiring (e.g. a twisted wire pair) is connected to one side of a terminating device 60, such as an IDC. Jumper wires having a modular connector or plug on one end may then be connected to the other side of the terminating device 60. The modular connector or plug is then connected to an electrical component on the PCB 52, such as an electrical-to-optical converter within components area 242 to electrically connect the subscriber wiring to the PCB 52. Alternatively, the subscriber wiring may be provided with a modular connector or plug that is received within modular receptacle or jack 256 protruding through panel 236 and mounted directly to PCB 52.

An excess length of the drop cable may be coiled within second compartment 212 in a clockwise direction under retaining members 72, or the retaining members 72 may be positioned over the second compartment 212 after the drop cable slack has been coiled therein in the event that the retaining members 72 are removable. If desired, optical fibers to be used initially may be separated from optical fibers that are to be stored within second compartment 212 and used later when the subscriber requires additional communications services. The unused, or “dark,” optical fibers (not shown) may be stored as bare fiber or in transport tubes within second compartment 212 along with the drop cable slack.

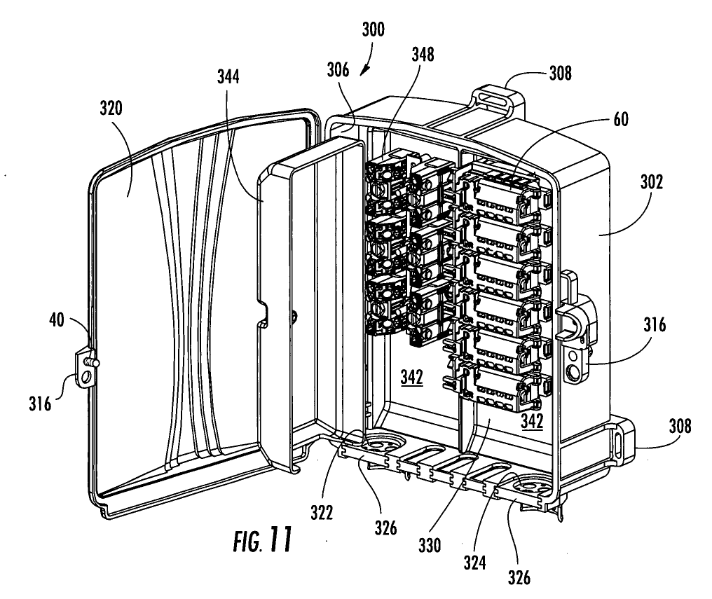

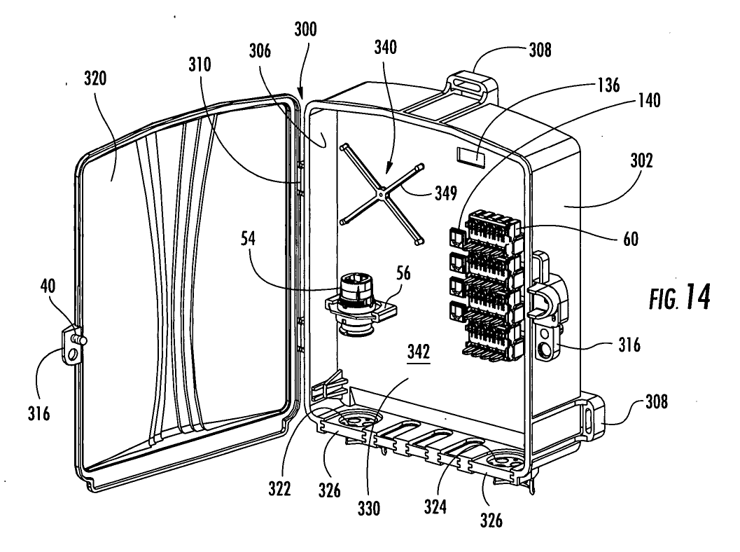

FIGS. 10-15 show various examples of another exemplary embodiment of a NID 300 according to the present invention. NID 300 includes base 302, protective outer cover 320, and a connections and/or components panel 330. Base 302 comprises a floor 304 (FIG. 13 and FIG. 15) and a continuous sidewall 306 depending upwardly around the periphery of the floor 304. As previously described, outer cover 320 is movably attached to base 304 between a closed position and an opened position shown in FIGS. 10-15. Preferably, hinges 310 are provided along one side of base 302 and outer cover 320 such that the outer cover 320 rotates about the hinges 310 between the closed position and the opened position. Means 316 are provided for securing the outer cover 320 on the base 302 in the closed position. As is well known, means 316 may comprise aligned openings in the outer cover 320 and the base 302 for receiving a subscriber combination or key lock and a security screw 40 that requires an industry specific tool to remove. The security screw 40 permits the service provider to override the subscriber lock and thereby gain access to the interior of the NID 300 for repair or to reconfigure the connections within the NID 300 without requiring the subscriber to remove the subscriber lock. Base 302 may also comprise feet 308 for mounting NID 300 to a wall at a subscriber premises. As shown, at least one network drop cable entry port 322 and at least one subscriber cable entry port 324 are provided along the lower edge of sidewall 306. Each such entry port 322, 324 may be formed by a removable grommet or penetrable seal 326, as previously described, to permit a network fiber optic drop cable and a subscriber cable, respectively, to enter the NID 300.

In each of the examples, the connections and components panel 330 is removably mounted within the interior of the NID 300 and thereby interchangeable with another panel 330 having a different configuration. In this manner, the service provider can initially install an empty NID 300, for example during construction of the subscriber premises, and subsequently install a connections and components panel 330 having a suitable configuration when the subscriber orders communications services. For example, the communication network may only support copper subscriber wiring or the subscriber may initially order only plain old telephone service (POTS). Accordingly, the service provider will install a removable and interchangeable connections and components panel 330 having a configuration suitable for both copper network wiring and copper subscriber wiring. Alternatively, the communications network may also support coaxial transmissions and the subscriber may desire both POTS and video services. Accordingly, the service provider will remove and replace the copper connections and components panel 330 with a different connections and components panel 330 configured for high-speed copper/coaxial voice and video transmissions. Later, the service provider may upgrade the network to a fiber optic communications network and the subscriber may desire voice, video and data services. Accordingly, the service provider will remove and replace the copper/coaxial connections and components panel 330 with a different connections and components panel 330 configured for high-speed voice, video and data transmissions. As such, the service provider can reduce or delay materials and field labor costs by utilizing the same NID 300 regardless of the type of communications network or the services desired by the subscriber. As a result, the service provider can readily upgrade the panel 330 as the transmission technology changes, or can customize subscriber installations to minimize equipment costs.

Connections and components panel 330 may be removably mounted within the interior of NID 300 in any suitable manner. Preferably, however, panel 330 is rotatably and detachably mounted to the lower edge of floor 304 or sidewall 306 such that panel 330 rotates between a closed position and an opened position. In the closed position, the panel 330 separates the interior of the NID 300 into a first (i.e. outer) compartment 340 and a second (i.e. inner) compartment 350. The first compartment 340 is defined by the area of base 302 within sidewall 306 and above panel 330. The second compartment 350 is defined by the area of base 302 within sidewall 306 and below panel 330 (i.e. the area between floor 304 and the inner surface of panel 330). As described hereinabove, the first compartment 340 comprises a connections area 342 for accommodating optical, electrical and or coaxial connections between the network fiber optic drop cable and the subscriber wiring. Similarly, the second compartment 350 comprises a components area 352 for accommodating passive and/or active optical, electrical coaxial components, such as an optical-to-electrical converter (O/E converter), an optical-to-coaxial converter, etc. Panel 330 is preferably supported by a plurality of standoffs 354 along the sidewall 306 of base 302 such that first compartment 340 is positioned at a fixed elevation above the floor 304. Connections area 342 may be shaped and sized within first compartment 340 in any desirable manner and components area 352 may likewise be shaped and sized within second compartment 350 in any desirable manner. Preferably, however, connections area 342 and components area 352 are positioned at different elevations with respect to floor 304 in a stacked or layered configuration. In particular, connections area 342 is positioned at a first elevation above floor 304 and components area 352 is positioned at a second elevation above floor 304 that is different than the first elevation.

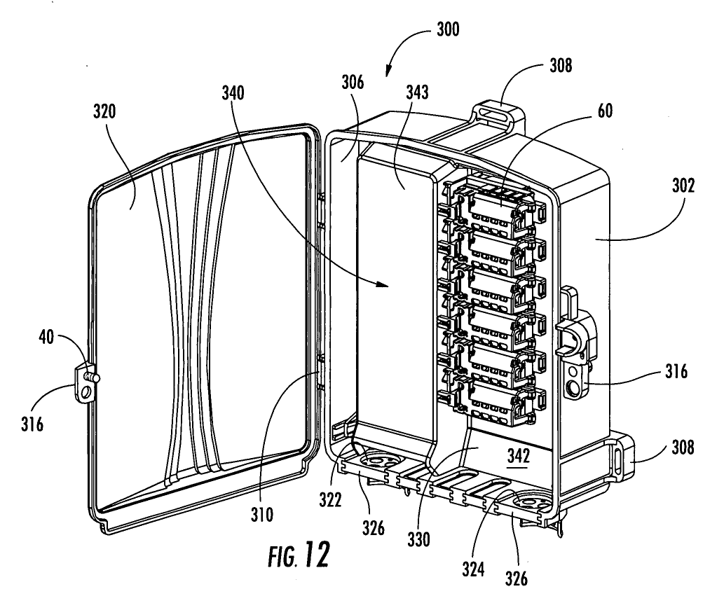

In a first example of the NID 300 shown in FIGS. 10 and 11, connections and components panel 330 comprises at least one terminating device 60 in connections area 342 for connecting subscriber wiring in the form of one or more copper twisted wire pairs from a subscriber cable with network wiring in the form of a copper twisted wire pair from a network electrical drop cable. First compartment 340 further comprises a service provider security shield or door 344, commonly referred to as a “Telco door,” disposed over a portion of connections area 342. As shown, door 344 is movably attached to panel 330 by hinges 345 located adjacent sidewall 306 such that door 344 rotates about hinges 345 between a closed position and an opened position. Door 344 is also provided with a security screw 346 that requires an industry specific tool to remove in the same manner as security screw 40 to prevent unauthorized access to termination equipment belonging to the service provider located on panel 330 beneath door 344. As shown in FIG. 11, connections area 342 further comprises at least one overvoltage surge protector 348, also referred to herein as a station protector, mounted on panel 330 beneath door 344. As is known, network wiring in the form of at least one copper twisted wire pair from a network electrical drop cable is routed through cable entry port 322 into connections area 342 beneath door 344 and electrically connected to a grounded station protector 348. Jumper wires are then routed from the station protector 348 to the corresponding terminating device 60 to electrically connect the network wiring to the subscriber wiring. As such, panel 330 provides termination equipment and electrical connections for a conventional copper communications network.

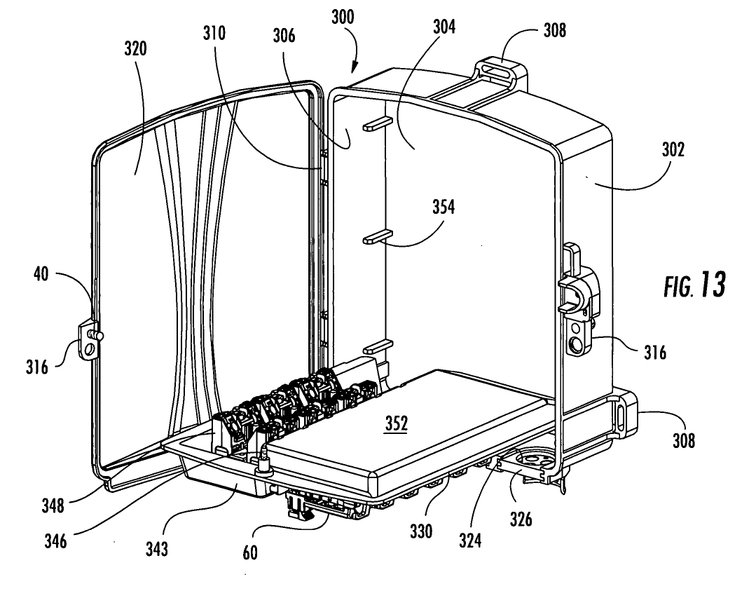

In a second example of the NID 300 shown in FIGS. 12 and 13, connections and components panel 330 again comprises at least one terminating device 60 in connections area 342 for connecting one or more copper twisted wire pairs from a subscriber cable with a copper twisted wire pair from a network electrical drop cable. The NID 300 in FIGS. 12 and 13 is identical to the NID 300 in FIGS. 10 and 11 except as described hereinafter. In particular, first compartment 340 further comprises a stepped cover 343 disposed over a portion of connections area 342 in place of the service provider Telco door 344 described in the previous example. Similar to door 344, stepped cover 343 is likewise provided with a security screw 346 (FIG. 13) that requires an industry specific tool to remove, and thereby prevents unauthorized access to termination equipment belonging to the service provider located beneath panel 330 in second compartment 350. As shown in FIG. 13, components area 352 comprises at least one station protector 348, mounted on the back (i.e. inner) side of panel 330 beneath stepped cover 343. As will be readily appreciated by those skilled in the art, the station protector(s) 348 may also be mounted on the floor 304 of the NID 300, or if the NID 300 has sufficient depth, on the back (i.e. inner) side of panel 330 opposite the terminating device(s) 60. Obviously, NID 300 may be configured in any desirable manner as long as station protectors 348 are located in the components area 352, and only the service provider has access to the components area 352. For example, panel 330 could be formed in halves with only the stepped cover 343 portion of panel 330 provided with security screw 348 and rotatable relative to the base 302 of NID 300. As is known, network wiring in the form of at least one copper twisted wire pair from a network electrical drop cable is routed through cable entry port 322 into components area 352 beneath stepped cover 343 and electrically connected to a grounded station protector 348. Jumper wires are then routed from the station protector 348 to the corresponding terminating device 60 in connections area 342 to electrically connect the network wiring to the subscriber wiring. As such, panel 330 provides termination equipment and electrical connections for a conventional copper communications network.

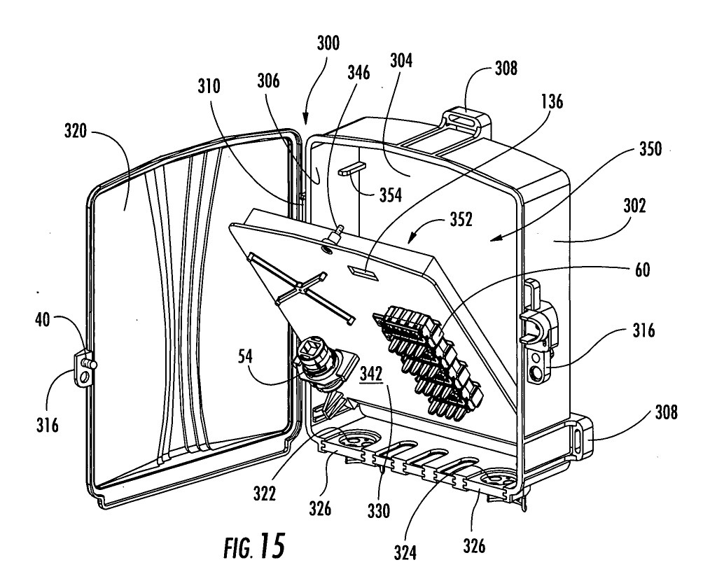

In a third example of the NID 300 shown in FIGS. 14 and 15, connections and components panel 330 is configured for a fiber optic communications network instead of a conventional copper communications network. As such, the panel 330 providing termination equipment and electrical connections shown in FIGS. 10 and 11 or FIGS. 12 and 13 is removed and replaced with the panel 330 shown in FIGS. 14 and 15 and described hereinafter. As shown, connections and components panel 330 comprises at least one terminating device 60 in connections area 342 for connecting subscriber wiring in the form of one or more copper twisted wire pairs from a subscriber cable with network wiring in the form of one or more optical fibers of a network fiber optic drop cable. First compartment 340 further comprises fiber optic connection 54 mounted on mounting bracket 56 for receiving a connectorized end of the network fiber optic drop cable through drop cable entry port 322, as previously described. A connectorized fiber optic pigtail (not shown) is connected to the other end of connection 54 and routed into components area 352 within second compartment 350 through panel port 136, as previously described. If desired, any excess length of the fiber optic pigtail may be coiled around and stored on slack storage hub 349. Panel 330 is provided with a security screw 346 (FIG. 15) that requires an industry specific tool to remove, and thereby prevents unauthorized access to termination equipment belonging to the service provider located beneath panel 330 in second compartment 350. The fiber optic pigtail is optically connected to an optical component on a passive or active component, such as the PCB 52 previously described, mounted on the back (i.e. inner) side of panel 330. PCB 52 preferably comprises an optical-to-electrical converter and jumper wires in the form of a copper twisted wire pair are routed from the PCB 52 to the terminating device 60 or the connector jack 140 on the front (i.e. outer) side of panel 330, as previously described. A copper twisted wire pair from a subscriber cable is routed through subscriber cable entry port 324 to the terminating device 60 or connector jack 140 to thereby electrically connect the network wiring to the subscriber wiring, as previously described. As such, panel 330 provides termination equipment and optical and electrical connections for a fiber optic communications network. Because the connections and components panels 330 shown in FIGS. 10-15 are each removable and interchangeable, the panel 330 shown in FIGS. 14 and 15 may be used to upgrade a conventional copper communications network to a fiber optic communications network or to expand the communications service from voice only to high-speed voice, video and/or data service.

Although preferred embodiments of the invention have been shown and described herein, many modifications and other embodiments of the invention will readily come to mind to one skilled in the art to which this invention pertains, and particularly, to one skilled in the art having the benefit of the teachings presented in the foregoing description and accompanying drawings. Therefore, it is to be understood that the invention is not intended to be limited to the specific embodiments disclosed herein and that further modifications and other embodiments are intended to be included within the scope of the appended claims. Although specific terms are employed herein, they are used in a generic and descriptive sense only and not for purposes of limitation.

That which is claimed is:

1. A network interface device for providing communications services to a subscriber, the network interface device comprising a first compartment, a second compartment and a connections and components panel, the panel having an outer side defining a connections area and an inner side defining a components area, the connections area positioned within the first compartment at a first elevation and the components area positioned the second compartment at a second elevation that is different than the first elevation.

2. The network interface device according to claim 1 wherein the panel is movably disposed between a first position for providing access to the connections area and a second position for providing access to the components area.

3. The network interface device according to claim 2 further comprising a base and wherein the panel comprises a security screw for securing the panel to the base in the first position and thereby prevents unauthorized access to the components area.

4. The network interface device according to claim 3 wherein the base comprises at least one drop cable entry port for receiving a network drop cable within the first compartment and at least one subscriber cable entry port for receiving a subscriber cable within the first compartment.

5. The network interface device according to claim 4 wherein the network drop cable is a fiber optic drop cable containing at least one optical fiber and wherein the connections area comprises a fiber optic connection for receiving a connectorized optical fiber of the fiber optic drop cable and a connectorized pigtail that is routed to the components area and optically connected to an optical component disposed within the second compartment.

6. The network interface device according to claim 5 wherein the optical component is disposed on a printed circuit board (PCB) comprising an optical-to-electrical converter.

7. The network interface device according to claim 4 wherein the subscriber cable is an electrical cable containing at least one twisted wire pair and wherein the connections area comprises at least one terminating device for receiving the twisted wire pair and a pair of jumper wires that are routed to the components area and electrically connected to an electrical component disposed within the second compartment.

8. The network interface device according to claim 4 wherein the network drop cable is a fiber optic cable containing at least one optical fiber and wherein the connections area comprises a splice tray for receiving the optical fiber of the fiber optic drop cable and an optical fiber pigtail that is routed to the components area and optically connected to an optical component disposed within the second compartment.

9. The network interface device according to claim 4 wherein the subscriber cable is an electrical cable containing at least one twisted wire pair and wherein the connections area comprises at least one connector jack for receiving the twisted wire pair and a pair of jumper wires that are routed to the components area and electrically connected to an electrical component disposed within the second compartment.

10. A network interface device for providing communications services to a subscriber, the network interface device comprising:
a base comprising a floor and a first sidewall extending upwardly from the floor; and
a connections and components panel movably mounted within the base and dividing the base into a first compartment and a second compartment, the panel having an outer side defining a connections area disposed within the first compartment and an inner side defining a components area disposed within the second compartment, the panel being movable between a first position for providing access to the connections area and a second position for providing access to the components area.

11. The network interface device according to claim 10 wherein the connections area is positioned at a first elevation relative to the floor and the components area is positioned at a second elevation relative to the floor that is different than the first elevation.

12. The network interface device according to claim 10 wherein the panel comprises a security screw for securing the panel to the base in the first position and thereby prevents unauthorized access to the components area.

13. The network interface device according to claim 10 wherein the panel is rotatably mounted to one of the floor and the sidewall and is rotated outwardly relative to the base between the first position and the second position.

14. The network interface device according to claim 10 wherein the base comprises at least one drop cable entry port for receiving a fiber optic drop cable containing at least one optical fiber within the first compartment and at least one subscriber cable entry port for receiving a subscriber cable containing at least one twisted wire pair within the first compartment.

15. The network interface device according to claim 14 wherein the connections area comprises a fiber optic connection for receiving a connectorized optical fiber of the fiber optic drop cable and a connectorized pigtail that is routed to the components area and optically connected to an optical component disposed within the second compartment.

16. The network interface device according to claim 14 wherein the connections area comprises a terminating device for receiving the twisted wire pair and a pair of jumper wires that are routed to the components area and electrically connected to an electrical component disposed within the second compartment.

17. The network interface device according to claim 14 wherein the connections area comprises a splice tray for receiving the optical fiber of the fiber optic drop cable and an optical fiber pigtail that is routed to the components area and optically connected to an optical component disposed within the second compartment.

18. The network interface device according to claim 14 wherein the connections area comprises at least one connector jack for receiving the twisted wire pair and a pair of jumper wires that are routed to the components area and electrically connected to an electrical component disposed within the second compartment.

19. A network interface device for providing communications services to a subscriber, the network interface device comprising:
a base having a floor and a sidewall; and
a first panel disposed within the base, the panel having a connections area and a components area defining a first configuration, the first panel being removably mounted within the base to be interchangeable with a second panel having a connections area and a components area defining a second configuration to upgrade or expand the communications services provided to the subscriber.

20. A network interface device according to claim 19 wherein the panel has an outer side comprising the connections area and an inner side comprising the components area and wherein the connections area is positioned within the base at a first elevation and the components area is positioned within the base at a second elevation that is different than the first elevation.
